(19) United States
(12) Patent Application Publication
(10) Pub. No.: US 2015/0219243 A1
(43) Pub. Date: Aug. 6, 2015

(54) CRYOGENIC FLUID TRANSFER TUNNEL ASSEMBLY AND USES THEREOF

(71) Applicants: Rakesh Kumar, Bangalore (IN); Michael George Said, Bangalore (IN)

(72) Inventors: Rakesh Kumar, Bangalore (IN); Michael George Said, Bangalore (IN)

(21) Appl. No.: 13/977,478

(22) PCT Filed: Dec. 23, 2011
(86) PCT No.: PCT/EP11/73911

§ 371 Date: Jun. 28, 2013

(30) Foreign Application Priority Data
Dec. 30, 2010 (EP) 10197377.4

(51) Int. Cl. F16L 1/12; B65G 5/00

(52) U.S. Cl. CPC F16L 1/12; B65G 5/00

(57) ABSTRACT

The present invention relates to a cryogenic fluid transfer tunnel that can be used as a liquefied natural gas (LNG) transfer tunnel. A lining jacket is provided, wherein a cryogenic fluid carrier line and one or more voids comprising cryogenic insulating material are located. A method of installing such a tunnel and a method of cooling a cryogenic fluid carrier line in such a tunnel is also described.

The present invention relates to a cryogenic fluid transfer tunnel assembly, and uses thereof.

An important embodiment of such a cryogenic fluid transfer tunnel is in the form a liquefied natural gas (LNG) transfer tunnel.

Natural gas is a useful fuel source, as well as being a source of various hydrocarbon compounds. It is often desirable to liquefy natural gas in a liquefaction facility at or near the source of a natural gas stream for a number of reasons. As an example, natural gas can be stored and transported over long distances more readily as a liquid than in gaseous form because it occupies a smaller volume and may not need to be stored at high pressures. Such liquefied natural gas can be stored at atmospheric pressure if maintained at cryogenic temperatures, such as at −160° C. or below. Alternatively, liquefied natural gas may be stored at temperatures above −160° C. if it is pressurised above atmospheric pressure.

The long distance transport of LNG may be carried out in a suitable LNG carrier, particularly a carrier vessel, such as an ocean-going tanker having one or more cryogenic storage tanks to maintain the LNG in a liquefied state. The carrier vessel may be supplied with LNG via a loading arm or hose from a LNG export terminal, which is connected to the liquefaction facility by one or more cryogenic fluid carrier lines. As used herein, the terms ‘line’ and ‘pipeline’ should be interpreted as equivalent and interchangeable.

After transport to the desired destination, LNG can be transferred from the LNG carrier vessel via an off-loading arm at a LNG import terminal. The LNG import terminal can supply LNG to a regasification facility via one or more LNG cryogenic fluid carrier lines. The regasification facility pressurises and vaporises LNG so that pressurised natural gas can be injected into a gas network at ambient temperature. If desired, a selected amount of one or more additional components, for example nitrogen, can be added at the regasification facility to obtain natural gas having a desired gas quality, for example a selected heating value (i.e. energy content when the natural gas is burned), according to gas specifications or the requirements of a consumer. Furthermore, the heating value of the natural gas may also be adjusted by removing or adding a desired amount of heavier hydrocarbons from natural gas.

LNG import and export terminals for LNG carrier vessels must be located at an on-shore jetty or off-shore, such as a distance of from a few hundred meters to more than a kilometre off-shore, depending upon the coastal water depth and local conditions, to allow access for the LNG carrier vessel to the terminal.

The LNG cryogenic fluid carrier line should maintain the LNG in a liquefied state while it is pumped between the facility and the terminal or vice versa. These carrier lines are normally insulated cryogenic pipelines supported on trestles formed of piles and concrete decking. The trestles may also carry ancillary lines, such as cryogenic fluid recirculation lines, vapour return lines, instrumentation lines and power lines. Each trestle may have a footprint many meters wide, typically greater than 4 m, for instance in the range of 4 m to 6 m.

It will be apparent that the cryogenic fluid carrier line connecting the facility and terminal will run on land from the facility to the shore and may have an off-shore portion.

In planning such cryogenic fluid carrier lines, the economic and environmental impact should be considered, both during installation and throughout the life of the pipeline. For instance, the total area of the on-shore land required to accommodate the associated trestle, together with an appropriate safety zone around the footprint of the trestle may be large. This may lead to significant CAPEX expenditure to purchase the requisite land, and impact the local population if the line and trestle may run through populated areas.

Furthermore, installation of an over-sea or sub-sea pipeline may affect a local ecosystem, for example when the supporting trestles are constructed for an over-sea pipeline or when a sub-sea pipeline is laid on the sea bed. Furthermore, the local economy may be affected by disruption to fisheries and (water) traffic, which may have to avoid the area around the pipeline. In addition, the line may also have to be modified to withstand the prevailing sea conditions. For instance the trestle may have to be strengthened and the cryogenic fluid carrier line rendered resistant to the corrosive properties of salt water. In arctic areas, the costs of constructing and maintaining trestles will increase even more.

There is thus a need to provide an alternative to such cryogenic fluid carrier lines which mitigates these problems, allowing installation and operation with a reduced environmental and economic impact to the surrounding area.

In a first aspect the present invention provides a cryogenic fluid transfer tunnel assembly, comprising a lining jacket comprising within a cryogenic fluid carrier line and one or more vapour return lines.

The lining jacket may suitably comprise within one or more, preferably a plurality of, voids holding cryogenic insulating material. Preferred embodiments further comprise a relief line for removing vapour from the one or more voids. The relief line may comprise a plurality of pores in fluid communication with the one or more voids.

The lining jacket may further comprise within at least one ancillary line, for instance in the form of a utility line. In preferred embodiments, the lining jacket may comprise within at least one utility line.

In a further aspect, the present invention provides the use of a cryogenic transfer tunnel assembly according to the first aspect, in transporting LNG between a LNG import terminal and a LNG regasification facility and/or between a LNG liquefaction facility and a LNG export terminal.

In another aspect, the present invention provides use of a cryogenic transfer tunnel assembly according to the first aspect, comprising the steps of:

allowing a liquid cryogenic fluid into a cryogenic fluid carrier line in the cryogenic fluid transfer tunnel assembly;

allowing a portion of the liquid cryogenic fluid in the cryogenic fluid carrier line to evaporate, thereby cooling the cryogenic fluid carrier line, and producing a vapour space within the cryogenic fluid carrier line, said vapour space comprising gaseous cryogenic fluid along the cryogenic fluid carrier line;

storing, and optionally cooling, a part of the gaseous cryogenic fluid; and

passing the stored and optionally cooled gaseous cryogenic fluid through the vapour return line and along the cryogenic fluid carrier line via a connecting line, thereby cooling the cryogenic fluid carrier line.

In a further aspect, the present invention provides a method of cooling a cryogenic fluid carrier line in a cryogenic fluid transfer tunnel as described herein comprising at least the steps of:

providing a cryogenic fluid carrier line with liquid cryogenic fluid;

allowing a portion of the liquid cryogenic fluid in the cryogenic fluid carrier line to evaporate, thereby cooling the cryogenic fluid carrier line, and producing a vapour space comprising gaseous cryogenic fluid along the cryogenic fluid carrier line;

storing and optionally cooling a part of the gaseous cryogenic fluid; and

passing the stored and optionally cooled gaseous cryogenic fluid through the vapour return line and along the cryogenic fluid carrier line via a connecting line, thereby cooling the cryogenic fluid carrier line.

In addition, the present invention provides a method of installing a cryogenic fluid transfer tunnel according to the first aspect by a trenchless installation method selected from the group comprising microtunnelling and horizontal direct drilling.

Embodiments of the present invention will now be described by way of example only and with reference to the accompanying non-limited drawings in which:

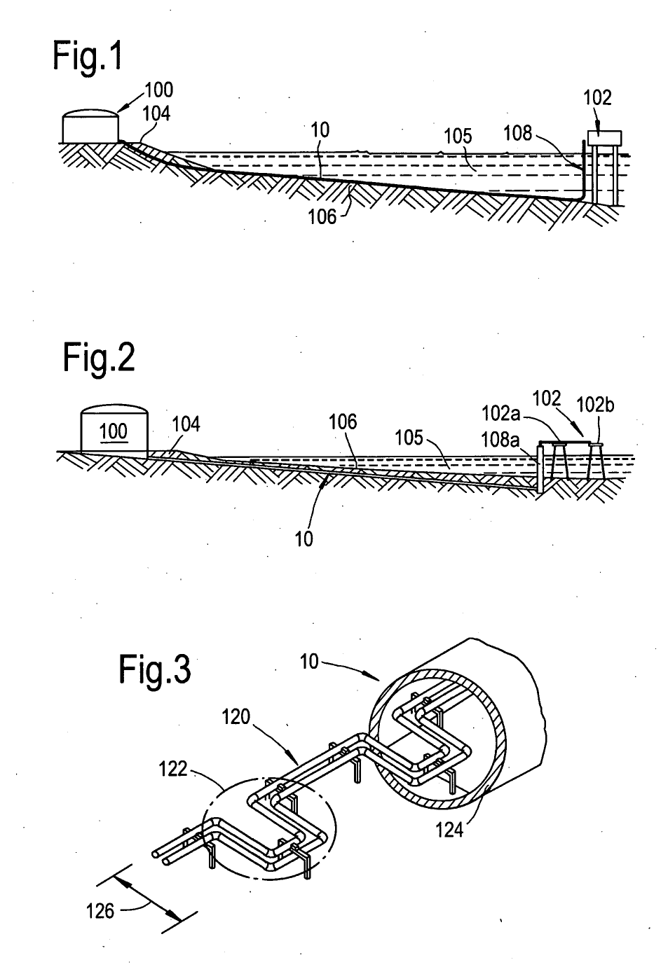

FIG. 1 shows a side-elevation in cross-section of a jettyhead and a storage terminal connected via a tunnel according to the present invention;

FIG. 2 shows a side-elevation in cross-section of a jettyhead and a storage terminal connected via a tunnel according to the present invention;

FIG. 3 shows a perspective view of a cross-section of a cryogenic fluid transfer tunnel according to an embodiment of the invention;

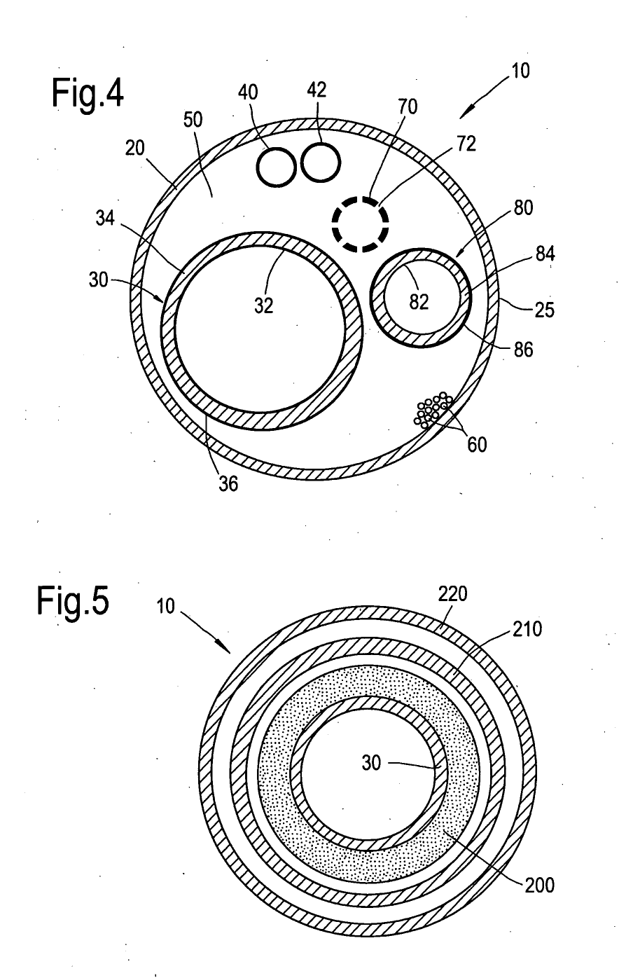

FIG. 4 shows a cross-section of a cryogenic fluid transfer tunnel according to another embodiment of the invention;

FIG. 5 shows a cross section of yet another embodiment of the tunnel of the present invention; and

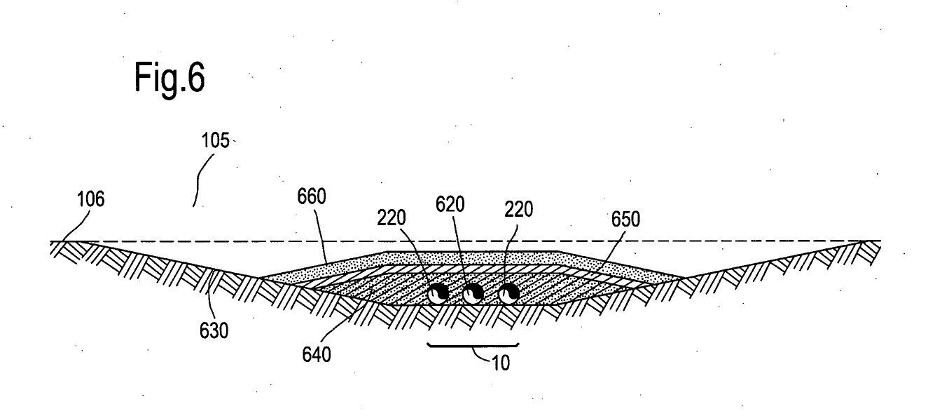

FIG. 6 shows a cross-section of a tunnel according to an embodiment of the present invention.

As discussed above, it is often desirable to liquefy hydrocarbon compositions, such as natural gas, at a liquefaction facility, in order to store and transport it, very often over long distances, as a liquid. The liquefied natural gas can then be regasified at the desired destination at a regasification facility, and passed, under pressure, to a gas network.

The liquefaction facility and the regasification facility may be separated by large distances, such as many hundreds, if not thousands of kilometres. It is not economic to lay cryogenic fluid carrier lines over such distances because of the cost involved in installing and operating such lines, particularly at the cryogenic temperatures required to maintain LNG in a liquid state. It is therefore common to have a LNG export terminal in the vicinity of the liquefaction facility, from which the LNG can be loaded onto a LNG carrier vessel and transported, normally by sea, to a corresponding LNG import terminal which can offload the LNG from a LNG carrier vessel and supply this to the regasification facility.

The cryogenic fluid transfer tunnel described herein and its method of installation and start-up are of particular use in connecting such terminals and facilities.

FIG. 1 shows a storage facility 100 which is connected to a jetty head 102 via a cryogenic fluid transfer tunnel 10 according to the present invention. The LNG storage facility 100 is located on land 104 and the jetty head 102 is located off-shore, typically in sea 105. The tunnel 10 is located on the seabed 106 and consequently resembles a subsea pipeline. For protection, the tunnel may be buried in a trench or may be covered with a protective layer (not shown). At the jetty end thereof, the tunnel 10 is connected to the jetty head via riser 108. Cargo carriers can berth at the jetty head to load or offload cargo.

The jetty head 102 may comprise a plurality of sub units that are independently supported on the sea bed 106. For example, the jetty head 102 as depicted in FIG. 2 consists of a riser platform 102a, which supports the riser 108, and a loading platform 102b on which an LNG berth is configured to allow berthing of the cargo carriers.

FIG. 2 shows the on-land storage facility 100 which is connected to the jetty head 102 via the tunnel 10, wherein the tunnel extends underground. I.e., the tunnel 10 is dug through the rock under the seabed 106. The riser may be provided in the form of a riser caisson 108a which may comprise a TBM receiving shaft. A TBM start shaft and pipe launching ramp may be provided on the on-shore end of the cryogenic fluid transfer tunnel 10.

FIG. 3 shows an embodiment of the cryogenic fluid transfer tunnel 10, wherein a conventional stainless steel LNG pipeline 120 with expansion loops 122 (see explanation below) with a conventional insulation system is considered. The pipeline 120 is arranged inside a dry tunnel 124. The expansion loops, which are made of the same material as the LNG pipeline, provide flexibility to the pipeline to accommodate contraction and expansion due to fluctuations in temperature. For instance, for a pipeline of about 1 km, a contraction of 3 m is expected for a decrease in temperature from 25 degree Celsius (room temperature) to −160 degree Celsius (the temperature of LNG at 1 bar). I.e., during cool down the LNG pipeline shortens and the expansion loops 122 are provided to accommodate the shrinkage. To insulate the pipeline 120, multiple layers of PIR (Polyisocyanurate) and/or PUR (Polyurethane) insulation material can be used in combination with generally two vapour barriers and external cladding to provide mechanical protection.

Theoretically, there is no limit for maximum spacing between two expansion loops 122. However, the pipeline 120 is arranged on pipe supports 126. Some of the pipe supports 126 are fixed to the pipeline, so no movement is possible, and other pipe supports allow one axis of movement, in the direction of the pipeline.

Another aspect of the expansion loop is the width 126 thereof. With greater spacing between respective expansion loops, the greater the movement at the corners of the expansion loop and hence the larger the loop required in order to limit the required rotation to maintain stress at these locations within suitable limits.

In principle, the greater the distance between subsequent expansion loops 122, the wider the expansion loops are. Conversely, a short distance between loops results in smaller expansion loop. However, there is a limitation on this. The minimum size that a loop can physically be made that still provides movement is approximately 4-times the pipe diameter. Therefore, for a pipe allowing transfer of LNG at a rate of 10,000 m3 per hour, a pipeline diameter of about 1 m (40 inch) would be required. If so, the dry tunnel 124 would have an inner diameter of for instance 7 m. In addition, the dry tunnel 124 is maintained in a dry condition.

The embodiment of FIG. 3 has the advantage that construction is straightforward and access to the pipeline is possible.

As an alternative, the expansion loops 122 may have a different form, compared to the substantially rectangular form shown in FIG. 3. For instance, the expansion loops 122 may be curved. Herein, the expansion loops will provide a series of interconnected shallow loops or bends. This curved expansion loop which lies in a horizontal plane can minimise the inner diameter of the dry tunnel 124. One such curve may for instance have a width of up to 2.3 m. In this case, the pipeline 120 can comprise 50% straight pipeline and 50% curved pipiline (including 45° elbows). For a reference LNG transfer condition of 10,000 m3 LNG per hour, the outer diameter of the pipeline 120 would be about 1.6 m and the inner diameter of the dry tunnel 124 would be about 5.5 m.

FIG. 4 shows a cross-section of a cryogenic fluid transfer tunnel 10. The cryogenic fluid transfer tunnel 10 comprises a lining jacket 20 which comprises within a cryogenic fluid carrier line 30; one or more voids 50 comprising insulating material 60; and one or more relief lines 70 for removing vapour from at least one of the one or more voids 50. Furthermore, the lining jacket comprises within a plurality of ancillary lines including: one or more utility lines 40, 42; and one or more vapour return lines 80. These lines are not shown to scale in FIG. 4. In preferred embodiments, the cryogenic fluid transfer tunnel assembly 10, particularly the lining jacket 20, does not comprise a cryogenic fluid recirculation line.

In one group of embodiments, any one of the ancillary lines may be formed by any one of the group consisting of: cryogenic fluid recirculation line; vapour return line; utility line. The utility line may comprise one or more from the group consisting of one or more nitrogen lines, one or more distributed control system lines, one or more power lines, one or more instrumentation lines and one or more signal cables. In another group of embodiments, any of the ancillary lines may be formed by any one of the group consisting of cryogenic fluid recirculation line; vapour return line; instrumentation line; and power line. Preferably, in any of the groups of embodiments listed in this paragraph, the cryogenic fluid recirculation line is not employed.

By bundling the cryogenic fluid carrier line 30 and ancillary lines inside the same lining jacket, and optionally by omitting a recirculation line, it is possible to significantly reduce the outer diameter of the cryogenic fluid transfer tunnel 10 as defined by the lining jacket 20. The outer diameter may be less than 2 m. Such cryogenic fluid transfer tunnels can be installed by trenchless installation methods which can lay the lining jacket and associated lines underneath the surface of the earth i.e. underground if on-shore or beneath the sea bed if off-shore.

The lining jacket 20 should provide both protection of the internal lines from the external, particularly underground, environment and also provide containment of the internal lines and their contents. The lining jacket 20 may be formed of concrete, such as reinforced concrete or steel, such as carbon steel. The outer perimeter. 25 of lining jacket 20 defines the outer surface of the cryogenic fluid transfer tunnel 10.

In the embodiment shown in FIG. 4 the lining jacket 20 is substantially circular in cross-section. As used herein, the term ‘cross-section’ is a section of the cryogenic fluid transfer tunnel 10 taken perpendicular to the central axis located along the largest dimension of the transfer tunnel 10.

The lining jacket may be provided in other shapes, although those of circular cross-section are preferred from the point of view of the trenchless installation techniques which may be employed.

Whatever the shape of the cross-section of the transfer tunnel 10, the cross-section may have a largest dimension of ≦4 m, or preferably ≦4 m, for instance in the range of from 1.5 to 2 m. In the embodiment shown in FIG. 4, the largest dimension of the cross-section will be the length of a line from outer perimeter 25 to outer perimeter 25 passing through the central axis of the transfer tunnel 10 i.e. the diameter of the cross-section of the lining jacket 20 perpendicular to the central axis.

The lining jacket 20 surrounds the cryogenic fluid carrier line 30 and ancillary lines and services. The cryogenic fluid carrier line 30 carries the cryogenic fluid. The cryogenic fluid is typically substantially liquid, such as LNG.

The cryogenic fluid carrier line 30 has an inner wall 32 made from a material appropriate for cryogenic service, such as a material selected from the group comprising 9% nickel steel, stainless steel such as SS 304L stainless steel, cryogenic plastic and FeNi36, and related alloys (also known by the trade name INVAR).

The cryogenic plastic used for the inner wall 32 may include a plastic composite material comprising a plastic matrix material reinforced by a reinforcer, wherein the composite material has a tensile Young's modulus of less than 50 GPa as determined according to DIN EN ISO 527 at atmospheric conditions and/or a tensile strain of 5% or less at ambient conditions. A suitable plastic composite material is for instance disclosed in WO-2008/068303, which is for this purpose included herein by reference.

Typically, the cryogenic fluid carrier line may be circular in cross-section and may have an external diameter in the range of from 75 to 125 cm, or in the range of 90 to 110 cm.

In one embodiment, the cryogenic fluid carrier line 30 comprises a material having a linear coefficient of thermal expansion of less than 2.5×10⁻⁶ K⁻¹, more typically less than 2.0×10⁻⁶ K⁻¹ (from −180 to 0° C.). Appropriate materials include FeNi36 and related alloys. Alternatively, the inner wall may comprise, or may be entirely made of, Forming the cryogenic fluid carrier line from a material having such a low linear coefficient of thermal expansion means that it is not necessary to incorporate expansion loops in the cryogenic fluid carrier line 30 to compensate for changes in the dimensions of the carrier line as a result of temperature changes. For instance, when the cryogenic fluid transfer tunnel 10 is dormant in between loading or off-loading operations, the cryogenic fluid carrier line 30 may increase in temperature as it begins to equilibrate with the external environment. However, in use, the temperature of the cryogenic fluid carrier line 30 may lower significantly, for instance to −160° C. or below when LNG is to be transferred. Consequently, if steps are not taken to compensate for these temperature fluctuations, it would not be possible to provide a cryogenic fluid supply tunnel 10 with a cross-sectional longest dimension of ≦2 m.

The cryogenic fluid carrier line may be surrounded by a layer of dedicated cryogenic insulation (34) such as aerogel or izoflex thermal insulation. The layer of dedicated cryogenic insulation may have a thickness in the range of about 0.5 to 15.0 cm.

The inner wall 32 and/or and the isolation layer 34 may be comprised within a protective outer wall 36. The outer wall 36 for instance comprises a carbon steel pipe.

One or more vapour return lines 80 may also be present inside the lining jacket 20. The vapour return line can transfer gas, typically boil off gas such as natural gas, from carrier vessel to the liquefaction or regasification facility. The boil off gas can arise from the evaporation of the liquefied cryogenic fluid, for instance in the storage tanks and associated pipework of the carrier vessel.

The temperature of the boil off gas may still be at or near cryogenic temperatures. The boil off gas can be compressed at the import or export terminal and transferred to the liquefaction or regasification facility along the vapour return line 80. Thus, in the embodiment in which the cryogenic fluid transfer tunnel connects a liquefaction facility with an export terminal, the flow of gas in the vapour return line will be in the opposite direction from the flow of cryogenic fluid in the cryogenic fluid carrier line. In the embodiment in which the cryogenic fluid transfer tunnel connects an import terminal with a gasification facility, the flow of gas in the vapour return line and the cryogenic fluid in the cryogenic fluid transfer tunnel will be in the same direction (i.e. from the import terminal to the regasification facility).

The vapour return line for instance has an inner diameter in the range of from 50 to 70 cm, for instance approximately 60 cm.

As a result of the cryogenic temperatures at which the vapour return line 80 may operate, the material for an inner wall 82 of the vapour return line may be selected from those discussed for the cryogenic fluid carrier line 30. Furthermore, the inner wall 82 of the vapour return line may be provided with a surrounding layer 84 of dedicated thermal insulation and/or be provided in a pipe-in-pipe configuration as discussed above for the cryogenic fluid carrier line 30. For instance the dedicated thermal insulation may be a layer of aerogel which may be surrounded by a carbon steel pipe 86.

One or more utility lines 40, 42 may also be located within the lining jacket 20. The utility lines 40, 42 may comprise one of more of the group selected from one or more nitrogen lines, one or more distributed control system lines, one or more power lines, one or more instrumentation lines and one or more signal cables. The power line can transmit electrical power from the liquefaction or regasification facility to the export or import terminal respectively, where for instance, it can be used to operate pumps and compressors and supply power to the carrier vessel while docked. The utility lines may be separate, or contained within the same utility line jacket. If separate, each utility line may have a diameter in the range of from 8 to 12 cm, more typically approximately 10 cm.

An annular space between the outer surfaces of lines 30, 40, 70 and 80 and the inner surface of lining jacket 20 comprises one or more voids 50. Typically the annular space will be at ambient pressure, although in some embodiments the annular space may be at less than ambient pressure. At least a portion of the one or more voids 50 may be occupied with cryogenic insulating material 60. The cryogenic insulating material may be selected from the group comprising an amorphous volcanic glass insulator such as perlite, an aerogel such as a silica aerogel and a foam, such as polyimide foam.

In the embodiment of FIG. 4, a bulk fill particulate insulating material 60, such as perlite beads, is shown. However, the insulating material may instead be in another form, typically a woven or non-woven structure such as a blanket or a porous foam. Whatever the form, it is important that the voids formed between (and/or within the insulating material if it is porous) are in fluid communication, so that any cryogenic fluid, such as liquefied cryogenic fluid or boil off gas which may leak into the annular space from one or both of the cryogenic fluid carrier line and vapour return line may be collected and removed from the annular space to prevent accumulation of flammable material.

The cryogenic fluid transfer tunnel 10 may further comprise one or more relief lines 70 for removing vapour from at least one of the one or more voids 50. The relief line 70 is provided with a plurality of pores or perforations 72 which are permeable to the cryogenic fluid, such as LNG and natural gas vapour. More typically, the relief line 70 may be a perforated line. The relief line 70 may be composed of a material selected from the group comprising carbon steel, stainless steel, and plastic, such as high density polyethylene.

The pores of the relief line 70 should be in fluid communication with one or more of the voids 50 to allow removal of leaked cryogenic fluid from the voids. It is apparent that the one or more voids 50 should also be in fluid communication to allow the passage of any fluid in the annular space to the relief line. For instance, the annular space with a particulate cryogenic insulating material or a foam cryogenic insulating material in which the cells of the foam are interconnected.

The relief line 70 may be placed under reduced pressure compared to that of the voids in the annular space in order to promote the removal of any leaked fluid. For instance, the relief line may be connected to a vacuum pump at one end of the tunnel for safe disposal.

The cryogenic fluid transfer tunnel 10 need not comprise a recirculation line for transferring cryogenic fluid, particularly LNG, in an opposite flow direction from that of the flow of cryogenic fluid in the cryogenic fluid carrier line 30. A recirculation line is conventionally present to allow the cooling of the cryogenic fluid carrier line to its operating temperature. For instance, cryogenic fluid, such as LNG, may be pumped along the cryogenic fluid carrier line from a liquefaction facility to an export terminal (or from an import terminal to a regasification facility) in order to cool the line to operational temperature by heat transfer between the line and the cryogenic fluid. Typically, a portion of the cryogenic fluid, which may be substantially in liquid form may be vaporised. At the termination of the cryogenic fluid carrier line, the cryogenic fluid may be passed to a gas/liquid separation vessel such as a knock-out drum. The liquid phase may be returned to the source of the cryogenic fluid (e.g. a liquefaction facility or carrier vessel) via a recirculation line. A recirculation line is not required in the cryogenic fluid carrier line disclosed herein.

The cryogenic fluid transfer tunnel 10 may further comprise a plurality of spacers to hold each of lines 30, 40, 70 and 80 in position in the annular space within lining jacket 20. Typically the spacers will allow fluid communication within the annular space from one side of a spacer to another and therefore do not segregate the annular space into fluid-isolated segments. The spacers may be comprised of steel, typically carbon steel or stainless steel.

The cryogenic fluid carrier line 30 may also be provided in a pipe-in-pipe configuration (FIG. 5) in which the carrier line with a layer of dedicated cryogenic insulation 200, comprising a cryogenic insulating material, is enclosed in a carbon steel or stainless steel pipe 210. The carrier line 30 and dedicated cryogenic insulation 200 may also be enclosed in multiple layer of piping. In the embodiment of FIG. 5, the cryogenic fluid carrier line 30 is enclosed in a lining jacket consisting in the form of a first pipeline 210, which is surrounded by a second lining jacket in the form of a second pipeline 220.

In a practical embodiment, the cryogenic fluid carrier line 30 comprises for instance FeNi36, FeNi9 or related alloys and/or may have an outer diameter of about 36 inch (90 cm). The first pipeline 210 is for instance made of stainless steel and/or may have an outer diameter of about 42 inch (107 cm). The second pipeline 220 is for, instance made of carbon steel and/or may have an outer diameter of about 44 inch (112 cm).

The cryogenic fluid transfer tunnel 10 may be installed by a trenchless installation method selected from the group comprising microtunnelling and horizontal direct drilling.

Laying the transfer tunnel by trenchless techniques minimises overgound disruption of the local populace and environment to the underground (or sea-bed) entry and exit points of the transfer tunnel during installation, rather than producing surface disruption along the entire length of the tunnel. Also, by laying the tunnel underground, a more protected environment for the cryogenic fluid carrier line is provided, particularly compared to a line running along the sea bed, while also reducing the hazard which such a carrier tunnel may represent were it to be laid at surface level. The, requirement to lay the line from a barge or crane onto the sea bed is also dispensed with. This can be a delicate operation, which if carried out incorrectly may damage the cryogenic fluid carrier line, and particularly the thermal insulation of such a line. It will also be apparent that the trestle that normally supports a cryogenic fluid carrier line and ancillary lines can also be eliminated. Furthermore, laying the transfer tunnel beneath the sea bed may provide significant CAPEX reductions because wave protection such as breakwaters will not be required.

Microtunnelling is useful for those situations in which the soil comprises sand, gravel, cohesive or rock types. Horizontal direct drilling may be used with cohesive and sand soil types.

When the trenchless installation method is microtunnelling, a jack pit is first excavated in the ground at one of the two sites which form either end of the cryogenic fluid transfer tunnel. Typically, when one end is on-shore and one end is off-shore, the jack pit will be excavated at the on-shore end of the cryogenic fluid transfer tunnel.

A thrust wall can then be constructed in the jack pit to provide reaction against which to jack. A pipe jack, such as a hydraulic jack, can then be installed in the jack pit positioned to achieve reaction against the thrust wall.

A tunnel from the jack pit to the site forming the other end of the cryogenic transfer tunnel can then be excavated, for instance using a remote controlled microtunneling machine. The tunnel should have a diameter of sufficient size to accommodate the lining jacket of the cryogenic fluid supply tunnel 10.

Lining jacket segments may then be pushed through the tunnel using the pipe jack. The lining jacket segments line the tunnel wall to provide the lining jacket of the cryogenic fluid transfer tunnel 10 and are therefore formed of the material used for the lining jacket already discussed. Typically, the lining jacket segments will be formed of concrete, such as reinforced concrete. Guide rails may be positioned in the thrust pit to ensure the correct alignment of the pipe jack and lining jacket segments.

The cryogenic fluid carrier line 30, one or more utility lines 40, one or more relief lines 70, one or more vapour return lines 80 and cryogenic insulating material 60 can then be fed inside the lining jacket 20 of the tunnel. All said lines may be fed inside the jacket at the same time.

It may be necessary to install intermediate jacking stations along the length of the tunnel should the jacking forces required to move the lining jacket 20 segments along the length of the installed pipeline be exceeded due to friction between the outer surface of the lining jacket 20 segments and the earth forming the walls of the excavated tunnel. Such intermediate jacking stations can reduce and distribute the jacking forces away from the pipe jack and thrust wall.

In an alternative embodiment, the trenchless installation method for the cryogenic fluid transfer tunnel 10 described herein may be horizontal direct drilling.

A subsurface pilot borehole between the two sites to form either end of the cryogenic fluid transfer tunnel 10 is first drilled. Typically, when one end of the tunnel is on-shore and one end is off-shore, the drilling is started from the on-shore site, although the drilling can be carried out from an off-shore end from a suitable drill rig if required. The drilling may be initiated from a pilot borehole of small diameter. The direction of the pilot borehole should be carefully controlled to follow the route of the cryogenic fluid transfer tunnel 10.

The pilot borehole may then be reamed, typically in one or more steps, to increase the diameter of the borehole to at least the outer diameter of the cryogenic fluid transfer tunnel to provide a preformed hole.

The cryogenic fluid transfer tunnel 10, which typically comprises a steel lining jacket, may then be pulled through the preformed hole from one of the two sites to the other site. This can be achieved providing the cryogenic fluid transfer tunnel with a towhead and pulling the tunnel through the preformed hole. Typically, drilling fluid may be retained in the preformed hole to protect the tunnel 10. The cryogenic fluid transfer tunnel 10 may be pulled through the preformed hole from an off-shore end of the tunnel, for instance by a jack-up platform.

As shown in FIG. 6, the cryogenic fluid transfer tunnel of the invention may comprise an assembly of two, three or more smaller tunnels. Herein, each tunnel may use the pipe-in-pipe configuration as shown in FIG. 5. The basic method of installation would be to drill small diameter tunnels, for instance of about 1.5 m to 2 m inner diameter. The pipelines can be prefabricated on land. Upon completion of the tunnels, the pipelines 220 would then be pulled through the respective tunnel and connected to a riser at the island berth.

The size and number of tunnels required would depend on the functionality required in the loading lines, for example, would recirculation of LNG be required to minimise boil-off, would fire water be provided at the island berth using sea water, or would fresh water be required to be piped to the jetty head. For instance, two tunnels can be provided: One pipe-in-pipe cryogenic fluid carrier line 30 within pipe 220 for transfer of LNG and a second pipeline 620 housing the utilities line and possibly the vapour return line. In a preferred embodiment, the assembly comprises three tunnels, including two pipelines 220 for LNG transfer (FIG. 6).

Advantages of this embodiment include the absence of expansion loops, and pipes can be pulled through the tunnels, making installation easier.

As shown in FIG. 6, the pipelines 220 and 620 may alternatively be buried in a trench 630 in the seabed 106. The sea bed may be formed of very soft clay. The horizontal dashed line represents the nominal level of the sea bottom if there would be no trench. In one embodiment, the bottom of the trench may comprise an 8.00 meters wide horizontal section, on which the pipelines 220 and 620 are supported. The horizontal section may be surrounded on both sides by slopes of 15° with the horizontal which climb to the seabed 106. The horizontal section may be recessed 3.00 meters below the nominal level of the sea bottom. The pipelines are arranged in the trench, and are thereafter covered with a number of protective layers. The protective layers may include one or more of a sand layer 640, a filter layer 650, and a layer of rock 660. Suitably the pipelines 220 and 620 are embedded within the sand layer 640 such that the pipelines 220 and 620 are fully covered by sand within the sand layer 640.

In one group of embodiments, the layer of rock may comprise of 10-60 kg of rock, and the top of the layer of rock 660 may be recessed by 0.50 meters below the nominal level of the sea bottom. The layer of rock 660 may be 0.60 meters thick. The filter layer 650 may be 0.40 meters thick. The sand layer 640 may be about 1.50 meters thick. The protective layers provide protection against dragging anchors, fishing nets, wave action and scour. The installation method could include prefabrication of the pipelines 220, 620 and launching from shore, or the pipelines can be fabricated on a barge and lowered directly into the preformed trench 630.

Using a trench rather than drilling tunnels has the additional advantage of a shorter construction schedule and cost savings.

In a further embodiment, a method of starting-up a cryogenic fluid transfer tunnel 10 as described herein is disclosed. In the present context, the terms ‘starting-up’ and ‘start-up’ relate to the transition of the tunnel from a holding state to a loading or off-loading state. Typically, during the holding state there is no or no appreciable flow of liquid cryogenic fluid in the cryogenic fluid carrier line 30 in the direction of loading or off-loading i.e. from a liquefaction facility to an export terminal (i.e. in a loading operation) or from an import terminal to a regasification facility (i.e. in an off-loading operation). Typically, during the loading or off-loading state there is a flow of liquid cryogenic fluid in the cryogenic fluid carrier line 30 in the direction of loading or off-loading.

In a first step, relief line 70 is depressurised to a pressure less than that of the annular space i.e. at least one of the one or more voids 50 which are in fluid communication with the relief line 70 in the cryogenic fluid transfer tunnel 10.

The cryogenic fluid carrier line 30 can then be cooled by passing a cooling fluid through the line to provide a cooled cryogenic fluid carrier line. The cooling fluid may be the liquefied cryogenic fluid itself, or gaseous cryogenic fluid at or near cryogenic temperature, such at the liquefaction temperature of the cryogenic fluid.

The conditions within the cryogenic fluid transfer tunnel 10 can be monitored from one or more sensors in the one or more utility lines 40. The sensors may, for instance, monitor one or more of the group comprising the temperature of the cryogenic fluid carrier line 30, the composition of any gas in the annular space, for instance in the one or more voids 50 and the temperature of the vapour return line 80.

When the sensor indicates that it is acceptable to do so, for instance when the temperature of the cryogenic fluid carrier line is at or below the liquefaction temperature of the cryogenic fluid, the cryogenic fluid can be pumped through the cooled cryogenic fluid carrier line, typically from a cryogenic fluid storage tank in the liquefaction facility or carrier vessel to an export terminal or regasification facility respectively.

After the loading or off-loading operation is complete, the cryogenic fluid transfer tunnel 10 may be returned to a holding state. During the holding state, the cryogenic temperatures may be maintained in the cryogenic fluid carrier line.

In a further aspect, a method of cooling a cryogenic fluid carrier line in a cryogenic fluid transfer tunnel assembly as described herein is disclosed.

In a first step, the cryogenic fluid carrier line is provided with liquid cryogenic fluid. This may be achieved as a result of a loading or unloading operation.

A portion of the liquid cryogenic fluid in the cryogenic fluid carrier line 30 may be allowed to heat up and boil off, thereby cooling the cryogenic fluid carrier line, to provide a vapour space in the cryogenic fluid carrier line 30. The vapour space will comprise gaseous cryogenic fluid (boil off gas).

The gaseous cryogenic fluid from the carrier line 30 can be stored, for instance in the vapour space of a cryogenic fluid storage tank, typically at the liquefaction or gasification facility.

Once sufficient liquid cryogenic fluid has evaporated to create a vapour space along the cryogenic fluid carrier line 30, gaseous cryogenic fluid from storage, such as the vapour space of the storage tank, can be passed along the vapour return line 80. Typically the gaseous cryogenic fluid may be near (i.e. slightly above) cryogenic temperature, that is the temperature required to maintain the cryogenic fluid in a liquid state. If necessary this may be cooled to near cryogenic temperature, for example by passage through a heat exchanger where it can be cooled against a liquefied cryogenic fluid stream, for instance from the liquefaction facility or a cryogenic fluid storage tank.

At or near the end of the vapour return line 80, typically at the import or export terminal end, a connection line with pressure reducing means, such as a valve, can be made to the cryogenic fluid carrier line 30. The pressure reducing means may be adjusted to allow the gaseous cryogenic fluid near cryogenic temperature from the vapour return line 80 to enter the cryogenic fluid carrier line 30 and pass along its length to cool it. This process will keep the carrier line 30 sufficiently cold to avoid any thermal expansion or any major delay in cooling the carrier line in preparation for the next transfer of cryogenic fluid.

During this operation, the flow of gaseous cryogenic fluid near cryogenic temperature along the vapour return line 80 may be in the opposite direction from the flow during loading or off-loading of a carrier vessel, when the gaseous cryogenic fluid as boil off gas is transferred from the carrier vessel to the liquefaction or regasification facility.

In an alternative embodiment disclosed herein, the cryogenic fluid carrier line may, be maintained filled with cryogenic liquid at all times. Gaseous cryogenic fluid generated in the carrier line may be sent to the vapour return line. In such an embodiment, the cryogenic fluid carrier line is in fluid communication with the vapour return line, for instance via a gas/liquid separator and/or pressure reducing means, such as a valve.

For instance, the cryogenic fluid from the cryogenic fluid carrier line could be sent to a gas/liquid separation vessel, from which the gaseous cryogenic fluid is send to the vapour return line.

The gaseous cryogenic fluid from the vapour return line can then be used for power generation or sent to a boil off gas compressor where it is converted back into a liquid. This embodiment is of particular use when the cryogenic fluid carrier line connects a liquefaction facility to an export terminal.

The present invention is not limited to the embodiments described above and can be carried out in various ways within the scope of the appended claims.

1. A cryogenic fluid transfer tunnel assembly comprising a lining jacket comprising within:
a cryogenic fluid carrier line;
a vapour return line; and
at least one void holding a cryogenic insulating material.

2. The cryogenic fluid transfer tunnel assembly of claim 1, wherein the lining jacket comprises within:
at least one relief line for removing vapor from the at least one void, whereby the at least one relief line comprises a plurality of pores in fluid communication with the at least one void.

3. The cryogenic fluid transfer tunnel assembly of claim 1, wherein the lining jacket comprises within at least one ancillary line.

4. The cryogenic fluid transfer tunnel assembly claim 1, wherein the lining jacket comprises within at least one utility line.

5. The cryogenic fluid transfer tunnel assembly of claim 4, wherein the at least one utility line comprises one of more of the group consisting of: nitrogen transport line, distributed control system line, power line, signal line, and instrumentation line.

6. The cryogenic fluid transfer tunnel assembly of claim 4, wherein the at least one utility line comprises an instrumentation line configured with one or more sensors, such as one or more of the group consisting of temperature sensor, pressure sensor and gas sensor.

7. The cryogenic fluid transfer tunnel assembly of claim 1, further comprising a connection line with pressure reducing means, between the cryogenic fluid carrier line and the vapor return line.

8. The cryogenic fluid transfer tunnel assembly of claim 1, wherein said cryogenic fluid transfer tunnel does not comprise a recirculation line.

9. The cryogenic fluid transfer tunnel assembly of claim 1, wherein the lining jacket has an outer diameter of ≦2 m.

10. The cryogenic fluid transfer tunnel assembly of claim 1, wherein the cryogenic fluid carrier line comprises a material having a linear coefficient of thermal expansion of less than 2.5×10⁻⁶ K⁻¹.

11. The cryogenic fluid transfer tunnel assembly of claim 10, wherein the cryogenic fluid carrier line does not comprise any expansion loops.

12. The cryogenic fluid transfer tunnel assembly of claim 1, wherein the lining jacket comprises concrete or steel.

13. The cryogenic fluid transfer tunnel assembly of claim 1, wherein the cryogenic insulating material comprises one of more of the group consisting of perlite and aerogel.

14. Use of a cryogenic fluid transfer tunnel assembly according to claim 1, in transporting LNG between one or both of a LNG import terminal and a LNG regasification facility and a LNG liquefaction facility and a LNG export terminal.

15. Use of a cryogenic fluid transfer tunnel assembly according to claim 1, comprising the steps of:
allowing a liquid cryogenic fluid into a cryogenic fluid carrier line in the cryogenic fluid transfer tunnel assembly;
allowing a portion of the liquid cryogenic fluid in the cryogenic fluid carrier line to evaporate, thereby cooling the cryogenic fluid carrier line, and producing a vapor space within the cryogenic fluid carrier line, said vapor space comprising gaseous cryogenic fluid along the cryogenic fluid carrier line;
storing, and optionally cooling, a part of the gaseous cryogenic fluid; and
passing the stored and optionally cooled gaseous cryogenic fluid through the vapor return line and along the cryogenic fluid carrier line via a connecting line, thereby cooling the cryogenic fluid carrier line.
